(19) United States
(12) Patent Application Publication
(10) Pub. No.: US 2003/0205649 A1
(43) Pub. Date: Nov. 6, 2003

(54) Ergonomic foam holder for cell phones and telephones

(76) Inventor: Raymond Saluccio, Colonia, NJ (US)

Correspondence Address: EZRA SUTTON, P.A., PLAZA 9, 900 ROUTE 9, WOODBRIDGE, NJ, 07095, US

(21) Appl. No.: 10/139,765

(22) Filed: May 6, 2002

(51) Int. Cl. F16M 11/00

(52) U.S. Cl. 248/176.1; 248/309.1

(57) ABSTRACT

The present invention provides a protective and ergonomic phone holder adapted to be used with various types of cell phones and land line telephone receivers defined herein generally as a phone. A support member is provided having a support surface on one side thereof for receiving a phone and a holding surface on the opposite side thereof for engaging the palm of the user's hand. Also, a device is provided for securing the support surface to the phone for holding the phone in place on the support surface. Gripping means on the side walls of the support member are also provided for gripping and holding the support member during a telephone conversation. Preferably, the support member is made from foam material.

### FIELD OF INVENTION

The present invention relates to an improved cell phone or telephone holder that can be produced in a plurality of shapes and sizes so as to be commensurate with the varied shapes, sizes and types of cell phones and telephone receivers.

### BACKGROUND OF THE INVENTION

By the design of the times, the telecommunication industry has proven an imperative need for simple and efficient communication devices. Thus, there has arisen various designs for cell phones and telephones to fulfill this need. However, although the goals of these designs is often reflective of durability, compactness, and efficiency; comfort is not always a priority. Moreover, with the increased use and time spent holding a telephone receiver or cell phone there is considerable stress placed on the hand muscles which not only causes considerable discomfort to the user, but which in turn may increase the risk of dropping the phone when switching it from hand to hand to relieve muscle stress. Thus, there is a need for an ergonomically efficient cell phone/telephone holder that provides comfort to the user as well as helping to protect the delicate workings of modern day cell phones and telephone receivers.

It is an object of the present invention to provide a cell phone/telephone holder that provides an ergonomical, efficient design and protection for cell phones and telephone receivers, as well as being compatible with a plurality of models of modern cell phones and telephones.

### DISCUSSION OF PRIOR ART

U.S. Pat. No. 4,733,776 discloses a protective device for a remote control including a resilient, deformable foam panel. A flexible transparent elastic member is adapted to extend across a channel, with a remote control device disposed within the channel opening. Hook or loop fastener patches are secured to opposed edges of the transparent member and are engageable with like loop or hook fastener patches secured to the outer peripheral surface of the foam panel, so that the transparent member applies tension to the opposed sides of the channel opening and frictionally retains the remote control unit therein.

### SUMMARY OF INVENTION

The present invention provides a protective and ergonomic phone holder adapted to be used with various types of cell phones and telephone receivers defined herein generally as a phone. A support member is provided having a support surface on one side thereof for receiving a phone and a holding surface on the opposite side thereof for engaging the palm of the user's hand. Also, a device is provided for securing the support surface to the phone for holding the phone in place on the support surface. Gripping means on the side walls of the support member are also provided for gripping and holding the support member during a telephone conversation. Preferably, the support member is made from foam material.

In alternate embodiments, the phone holder may be of various shapes such as circular, oval, rectangular, hourglass shaped, or shaped with finger-receiving cavities.

In alternate embodiments, instead of resting on the phone holder, the phone may be embedded within the holder. In addition, the phone holder may provide a dual function and also serve as an exercise device for exercising the user's hand during a telephone conversation.

In alternate embodiments, the phone holder may be in the shape of a semi-cylindrical or rectangularly shaped support member for flexibly gripping a phone.

### BRIEF DESCRIPTION OF THE DRAWINGS

FIG. 1 is a perspective view of a cell phone secured to the top surface of a phone holder wherein the gripping means includes a plurality of finger-receiving cavities.

FIG. 1a is a cross sectional view of a cell phone secured to the top surface of a phone holder.

FIG. 2 is a perspective view of a cell phone embedded in the top surface of a phone holder wherein the gripping means includes a plurality of finger-receiving cavities.

FIG. 3 is a perspective view of a cell phone within a semi-cylindrical shaped phone holder.

FIG. 3a is a perspective view of cell phone within a semi-cylindrical shaped phone holder in the open position.

FIG. 3b is a perspective view of a rectangular shaped phone holder with rounded corners for receiving a cell phone therein.

FIG. 4 is a perspective view of a cell phone within a semi-cylindrical shaped phone holder enclosed within a stretchable pocket.

FIG. 4a is a perspective view of a cell phone within a semi-cylindrical shaped phone holder enclosed within a molded pocket.

FIG. 5 is a perspective view of a cell phone attached to the top surface of a rectangular shaped phone holder with rounded corners.

FIG. 6 is a perspective view of a cell phone attached to the top surface of a circle shaped phone holder.

FIG. 7 is a perspective view of a cell phone attached to the top surface of an hourglass shaped phone holder.

FIG. 8 is a perspective view of a cell phone attached to the top surface of an oval shaped phone holder.

FIG. 9 is a perspective view of a telephone receiver secured to the top surface of a phone holder wherein the gripping means includes a plurality of finger-receiving cavities.

FIG. 9a is a cross sectional view of a telephone receiver secured to the top surface of a phone holder.

FIG. 10 is a perspective view of a telephone receiver attached to the top surface of a rectangular shaped phone holder with rounded corners.

FIG. 11 is a perspective view of a telephone receiver attached to the top surface of a round shaped phone holder.

FIG. 12 is a perspective view of a telephone receiver attached to the top surface of an oval shaped phone holder.

FIG. 13 is a perspective view of a telephone receiver attached to the top surface of an hourglass shaped phone holder.

FIG. 14 is a perspective view of another embodiment of a cell phone and holder.

### DETAILED DESCRIPTION OF THE PREFERRED EMBODIMENTS

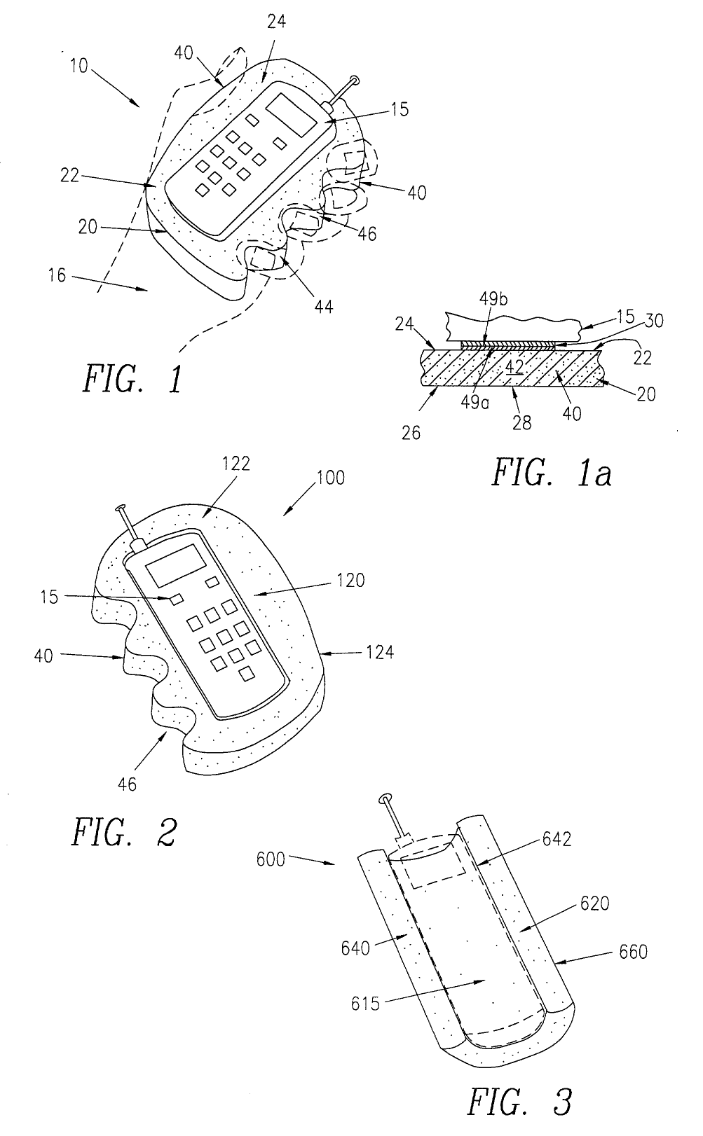

FIGS. 1 and 1a show a protective and ergonomic phone holder 10 adapted to be used with various types of cell phones defined herein generally as a phone 15. The phone holder is comprised of a support member 20 having a support surface 22 on one side of thereof 24 for receiving a phone 15; a holding surface 26 on the opposite side 28 for engaging the palm of the user's hand 16. A device 30 is provided for securing the support surface 22 to the phone 15 and holding it in place on the support surface 22. Also, Velcro strips 49a and 49b are used to secure the phone 15 to the support surface 22. In addition, gripping means 40 in the form of gripping surfaces are provided on the side walls 42, 44 of the support member 20 for gripping and holding the support member 20 during a telephone conversation. The support member 20 can be made from all types of foam, from silicone gel encased in a fabric, e.g. nylon, other plastics, polyurethane, neoprene, rubber and related materials. In addition, the gripping means 40 preferably includes a plurality of finger-receiving cavities 46.

FIG. 2 shows an alternate embodiment of the phone holder 100 wherein the support surface 120 has a recess 122 formed within the support member 124 for receiving the phone 115 embedded within the recess 122. In this embodiment, the support member 124 can also be an exercise device for exercising the user's hand 116 during a telephone conversation.

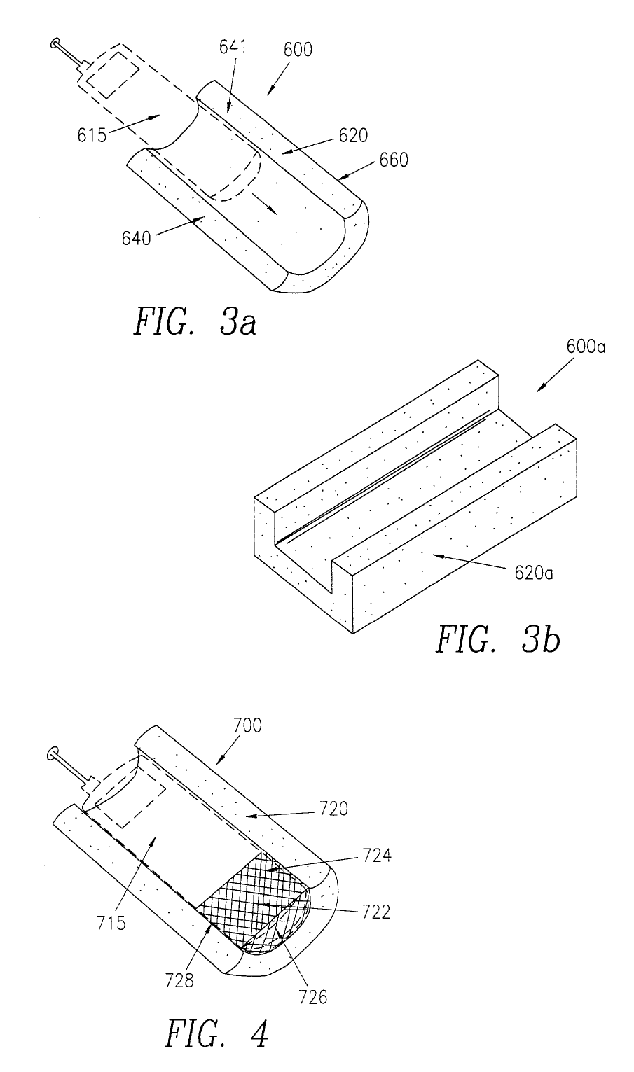

FIGS. 3 and 3a show an alternate embodiment of a phone holder 600. A semi-cylindrical shaped support member 620 is provided having a support surface 640 on one side thereof for receiving a phone 615 and having a holding surface 660 on the opposite side thereof for engaging the palm of the user's hand 666. The support member 620 is constructed to flexibly grip the phone 615 for holding the phone 615 in place on the support surface 640. This is accomplished by making the support member 620 from a flexible foam for gripping the phone 615. In this manner, the foam support member 620 stretches so that support surface 640 is movable to an open receiving position 641 for receiving the phone and for releasing the support surface 640 for returning it to a closed position 642 for gripping and holding the phone 615 in place. Support member 620 has a longitudinal length in the range of 1″ to 7″, an outer diameter in the range of 1.5″ to 6″, an inner diameter in the range of 1″ to 3″, and a thickness in the range of 1/16″ to 1.5″.

FIG. 3b shows an alternate embodiment of a phone holder 600a in which the support member 620a is in the shape of a rectangle with rounded corners.

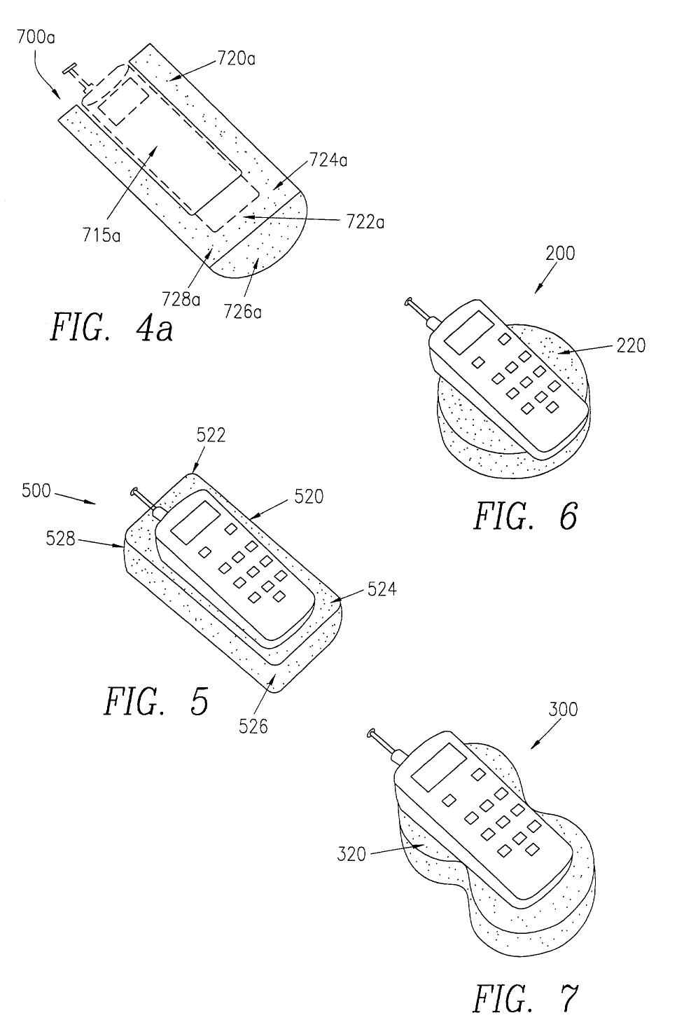

FIG. 4 shows an alternate embodiment of a phone holder 700 wherein the support member 720 is partially enclosed to form a pocket 722 for receiving and holding the phone 715. The pocket 722 involves a stretchable member 724 extending across the bottom 726 and top 728 of the support member 720.

FIG. 4a shows an alternate embodiment of a phone holder 700a wherein the support member 720a is partially enclosed to form a pocket 722a for receiving and holding the phone 715a. The pocket 722a involves a molded member 724a extending across the bottom 726a and top 728a of the support member 720a.

FIG. 5 shows an alternate embodiment of a phone holder 500 wherein the support member 520 is in the shape of a rectangle with rounded corners 522, 524, 526, 528.

FIG. 6 shows an alternate embodiment of a phone holder 200 wherein the support member 220 is in the shape of a circle.

FIG. 7 shows an alternate embodiment of a phone holder 300 wherein the support member 320 is in the shape of an hourglass.

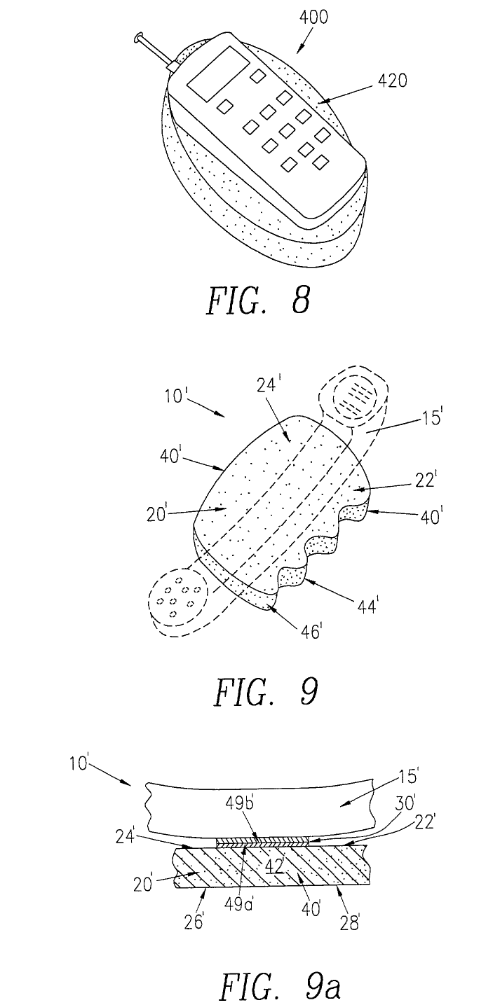

FIG. 8 shows an alternate embodiment of a phone holder 400 wherein the support member 420 is in the shape of an oval.

FIGS. 9 and 9a show a protective and ergonomic phone holder 10′ adapted to be used with various types of telephone receivers defined herein generally as a phone 15′. The phone holder is comprised of a support member 20′ having a support surface 22′ on one side of thereof 24 for receiving a phone 15′; a holding surface 26′ on the opposite side 28′ for engaging the palm of the user's hand 16′. A device 30′ is provided for securing the support surface 22′ to the phone 15′ and holding it in place on the support surface 22′. Also, Velcro strips 49a′ and 49b′ are used to secure the phone 15′ to the support surface 22′. In addition, gripping means 40′ in the form of gripping surfaces are provided on the side walls 42′, 44′ of the support member 20′ for gripping and holding the support member 20′ during a telephone conversation. The support member 20′ is preferably made primarily from foam material. In addition, the gripping means 40′ preferably includes a plurality of finger-receiving cavities 46′.

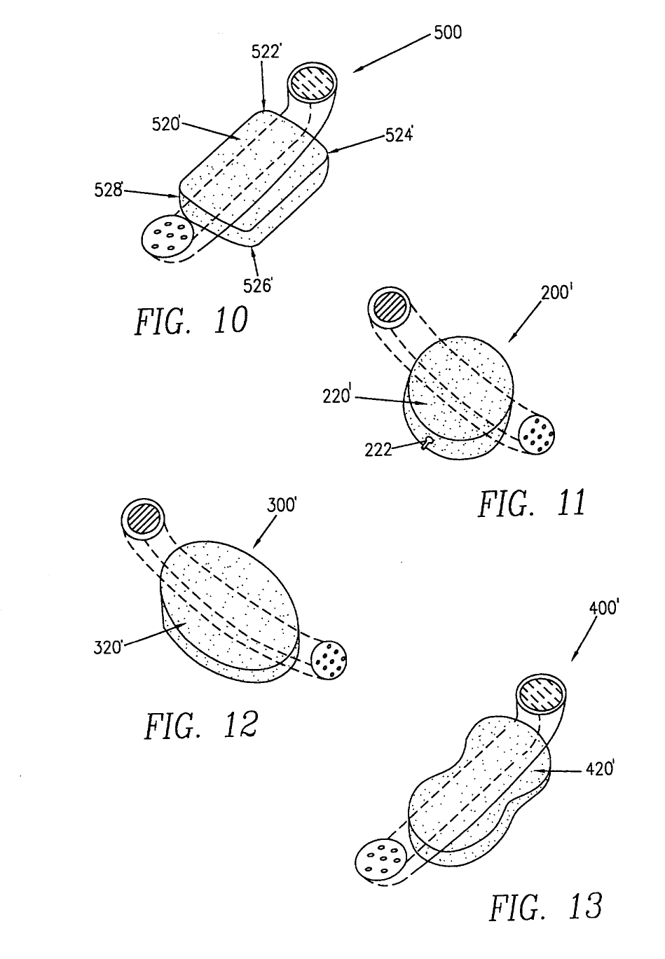

FIG. 10 shows an alternate embodiment of a phone holder 500′ wherein the support member 520′ is in the shape of a rectangle with rounded corners 522′, 524′, 526′, 528′.

FIG. 11 shows an alternate embodiment of a phone holder 200′ wherein the support member 220′ is in the shape of a circle, and includes a mouthpiece and valve 222 for inflating the support member with air. It should be understood that any of the support members shown herein may be inflatable with air, and may be made from materials including vinyl, plastic, or rubber.

FIG. 12 shows an alternate embodiment of a phone holder 300′ wherein the support member 320′ is in the shape of an oval.

FIG. 13 shows an alternate embodiment of a phone holder 400′ wherein the support member 420′ is in the shape of an hourglass.

Another alternate embodiment of this invention encompasses holders as shown above for all cell phones and land line telephone handsets being made from a plastic, vinyl or rubber material which is inflatable with air, and includes a valve and mouth piece for the user to inflate the holder with air to regulate the firmness or softness of the phone holder.

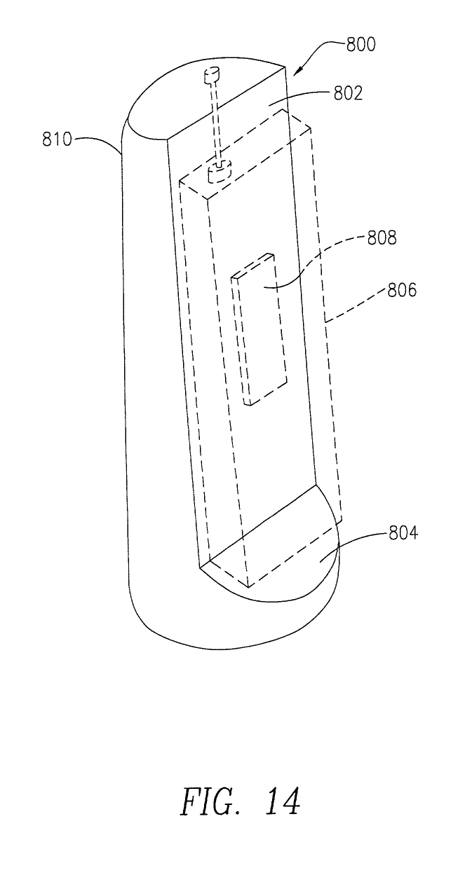

FIG. 14 shows an alternate embodiment of another telephone holder 800 having a flat receiving surface 802, a lower ledge member 804, and a semi-cylindrical surface 810. The cell phone 806 is attached to surface 802 by Velcro 808.

Advantages of the Present Invention

It is an advantage of the present invention to provide a cell phone/telephone holder that provides a comfortable, ergonomical, efficient design and provides protection for cell phones and land line telephone receivers, as well as being compatible with a plurality of various makes and models of modern cell phones and telephones.

A latitude of modification, change, and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1. A protective and ergonomic phone holder adapted to be used with various types of cell phones and land line telephone receivers defined herein generally as a phone, comprising:
a) a support member having a support surface on one side thereof for receiving a phone and a holding surface on the opposite side thereof for engaging the palm of the user's hand;
b) means for securing said support surface to the phone for holding the phone in place on said support surface;
c) gripping means on the side walls of said support member for gripping and holding said support member during a telephone conversation; and
d) said support member being made from a material selected from the group consisting of all types of foam, silicone gel, plastic, polyurethane, neoprene, rubber and related materials.

2. A protective and ergonomic phone holder in accordance with claim 1, wherein said gripping means includes gripping surfaces having a plurality of finger-receiving cavities.

3. A protective and ergonomic phone holder in accordance with claim 1, wherein said support surface has a recess formed within said support member for receiving the phone embedded within said recess.

4. A protective and ergonomic phone holder in accordance with claim 1, wherein said support member is also an exercise device for exercising the user's hand while during a telephone conversation.

5. A protective and ergonomic phone holder in accordance with claim 1, wherein said support member is in the shape of a circle.

6. A protective and ergonomic phone holder in accordance with claim 1, wherein said support member is in the shape of an oval.

7. A protective and ergonomic phone holder in accordance with claim 1, wherein said support member is in the shape of an hourglass.

8. A protective and ergonomic phone holder in accordance with claim 1, wherein said support member is in the shape of a rectangle, with curved corners.

9. A protective and ergonomic phone holder in accordance with claim 1, wherein said means for securing are Velcro strips attached to the phone and to said support surface.

10. A protective and ergonomic phone holder adapted to be used with various types of cell phones and land line telephone receivers defined herein generally as a phone, comprising:
a) a semi-cylindrical shaped support member having a support surface on one side thereof for receiving a phone and a holding surface on the opposite side thereof for engaging the palm of the user's hand;
b) means for flexibly gripping said support member around the phone for holding the phone in place on said support surface;
c) said support member being made from foam material; and
d) wherein said means for flexibly gripping said support member includes means for stretching said support surface to an open receiving position for receiving the phone, and for releasing said support surface for returning it to a closed position for holding the phone in place.

11. A phone holder in accordance with claim 10, wherein said support member being partially enclosed to form a pocket for receiving and holding the phone.

12. A phone holder in accordance with claim 11, wherein said pocket includes a stretchable member extending across the bottom of said support member.

13. A phone holder in accordance with claim 11, wherein said pocket includes a stretchable member extending across the top of said support member.

14. A phone holder in accordance with claim 10, wherein said support member's longitudinal length is in the range of 1″ to 7″.

15. A phone holder in accordance with claim 10, wherein said support member's outer diameter is in the range of 1.5″ to 6.5″ and the inner diameter is in the range of 1″ to 3″.

16. A phone holder in accordance with claim 10, wherein said support member's thickness is in the range of 1/16″ to 1.5″.

17. A phone holder in accordance with claim 10, wherein said support member is made from a material selected from the group consisting of all types of foam, silicone gel, plastic, polyurethane, neoprene, rubber and related materials.

18. A protective and ergonomic phone holder adapted to be used with various types of cell phones and land line telephone receivers defined herein generally as a phone, comprising:
a) a rectangular shaped support member having a support surface on one side thereof for receiving a phone and a holding surface on the opposite side thereof for engaging the palm of the user's hand;
b) means for flexibly gripping said support member around the phone for holding the phone in place on said support surface;
c) said support member being made from foam material; and
d) wherein said means for flexibly gripping said support member includes means for stretching said support surface to an open receiving position for receiving the phone, and for releasing said support surface for returning it to a closed position for holding the phone in place.

19. A phone holder in accordance with claim 10, wherein the holder is made from a plastic, vinyl or rubber material which is inflatable with air, and includes a valve and mouth piece for the user to inflate the holder with air to regulate the firmness or softness of the phone holder.

20. A protective and ergonomic phone holder adapted to be used with various types of cell phones and land line telephone receivers defined herein generally as a phone, comprising:
a) a support member having a flat support surface on one side thereof for receiving a phone and a semi-cylindrical holding surface on the opposite side thereof for engaging the palm of the user's hand; said flat support surface including a ledge member at the base thereof for supporting and protecting the phone;
b) means for securing said support surface to the phone for holding the phone in place on said support surface;
c) side walls of said support member being used for gripping and holding said support member during a telephone conversation; and
d) said support member being made from a material selected from the group consisting of all types of foam, silicone gel, plastic, polyurethane, neoprene, rubber and related materials.

21. A protective and ergonomic inflatable phone holder adapted to be used with various types of cell phones and land line telephone receivers defined herein generally as a phone, comprising:
a) a support member having a support surface on one side thereof for receiving a phone and a holding surface on the opposite side thereof for engaging the palm of the user's hand;
b) means for securing said support surface to the phone for holding the phone in place on said support surface;
c) said support member being used for gripping and holding said support member during a telephone conversation; and
d) said support member being made from a material selected from the group consisting of plastic, vinyl and rubber, and including means for inflating said support member with air.
